(19) United States
(12) Patent Application Publication
(10) Pub. No.: US 2020/0097938 A1
(43) Pub. Date: Mar. 26, 2020

(54) PROCESSING PLATFORM

(71) Applicant: Coin Flip Solutions, Inc., Plano, TX (US)

(72) Inventors: Larry van der Veen, San Carlos, CA (US); William M. Catania, Plano, TX (US)

(21) Appl. No.: 16/577,784

(22) Filed: Sep. 20, 2019

Related U.S. Application Data
(60) Provisional application No. 62/734,101, filed on Sep. 20, 2018.

(51) Int. Cl. G06Q 20/20

(52) U.S. Cl. CPC G06Q 20/202; G06Q 20/206

(57) ABSTRACT

A processing platform is introduced that enables seamless integration between various components in a network-connected payment processing ecosystem to enable, for example, the conversion of points and miles to spendable cash, rewards and discounts, selective spending from third-party funded purses, scoring and weighting of basket items for rule-based filtering, and tracking and reporting consumer spending behavior by market basket content.

### CROSS-REFERENCE TO RELATED APPLICATION(S)

This application is entitled to the benefit and/or right of priority of U.S. Provisional Application Ser. No. 62/734,101 titled, “PROCESSING PLATFORM,” filed Sep. 20, 2018, the contents of which are hereby incorporated by reference in their entirety for all purposes. This application is therefore entitled to a priority date of Sep. 20, 2018.

### BACKGROUND

Many brick and mortar merchants utilize electronic point of sale (POS) terminal systems to perform purchase tallying and payment processing including electronic payments. Payments submitted, for example through the use of a payment card at a POS terminal, are processed using one or more payment networks. Payment networks may comprise the infrastructure associated with traditional electronic payment rails that connect consumers with merchants and banks for the purposes of transferring funds electronically. Issuer processors may handle processing of payment (authorization, approval, denial, etc.) via the traditional payment rails of payment networks.

### BRIEF DESCRIPTION OF THE DRAWINGS

FIG. 1 shows a diagram of an example networked computing environment in which the introduced processing platform can be implemented;

FIG. 2 shows an architecture and flow diagram of an example computing architecture that includes the introduced processing platform;

FIG. 3 shows a flow diagram illustrating an example process for spending with purse management using the introduced processing platform;

FIG. 4 shows a flow diagram illustrating an example process for catalog management using the introduced processing platform;

FIG. 5 shows a flow diagram illustrating an example process for points/miles acquisition using the introduced processing platform;

FIG. 6 shows a flow diagram illustrating an example process for points/miles redemption using the introduced processing platform;

FIG. 7 shows a flow diagram illustrating an example process for rewards and incentives redemption using the introduced processing platform;

FIGS. 8A-8B show example data elements that may be included in a market basket request;

FIGS. 9A-9B show example data elements that may be included in a market basket response;

FIG. 10 shows example data elements that may be included in an earning event request;

FIG. 11 shows example data elements that may be included in an earning event response;

FIG. 12 is a block diagram of an example computing system as may be used to implement certain features of the introduced processing platform.

### DETAILED DESCRIPTION

### Overview

A processing platform is introduced that enables seamless integration between various components in a network-connected payment processing ecosystem to enable, for example, the conversion of points and miles to spendable cash, rewards and discounts, selective spending from third-party funded purses, scoring and weighting of basket items for rule-based filtering, and tracking and reporting consumer spending behavior by market basket content. As will be described, in some embodiments, the introduced processing platform can be implemented as a cloud-based Software as a Service (SaaS) and/or may be integrated into existing networks such as merchant networks, financial networks, etc. In some embodiments, services offered through the processing platform are accessed through web service application programming interfaces (APIs) that expose various functionality such as rules adjudication for alternative currency spend, discounts, filtered spending, administrative management, for example, to facilitate point conversion with points providers, discount offer and campaign management, nutritional assessment, product catalog management, financial settlement, and reporting of transaction details.

Certain embodiments of the introduced processing platform are described with respect to several entities that have varying roles with respect to the processing platform. These various entities include the following:
Members: Members are users that utilize the services of the processing platform, for example, when purchasing goods offered by merchants. Members may access the services offered by the processing platform, for example, by using a personal computing device such as a mobile phone or by confirming identity via merchant point of sale (POS) systems. In some embodiments, members may have accounts with other entities such as merchants, goods/services providers, benefit providers, points providers, banks, affiliates, or a provider of the introduced processing platform and may elect to link one or more of these accounts, for example, to utilize certain functionality of the processing platform such as alternative currency spend.
Merchants: Merchants may include any entities that offer goods and/or services to members. Merchants may include, for example, wholesalers, retailers (e.g., grocery stores, drug stores, restaurants, etc.), direct-to-consumer service providers, and any other such entities. In some embodiments, merchants may offer products and services to members in exchange for payment facilitated, at least in part, by the processing platform along with existing retailer POS systems, loyalty infrastructure, payment networks, etc.
Goods and/or Services Providers: Goods and/or services providers may include any entities that manufacture and distribute goods and/or provide services that are then offered, for example, via intermediaries such as merchants. For example, a goods provider may include a consumer-packaged goods (CPG) provider (e.g., Coca-Cola™) that produces CPGs such as packaged foods and beverages that are then distributed to and sold to members by retailer merchants such as grocery stores.
Benefits Providers: Benefits providers may include private and/or government sponsored benefit plans such as health plans, other insurance plans, nutritional assistance plans, unemployment benefit plans, disability plans, etc. As will be described, members may have associated accounts or purses managed by one or more benefits providers that include benefit funds that can be used to purchase certain goods and services from merchants. In some cases, benefits providers may impose rules governing purse spending that restrict, for example, the products and/or services that can be purchased using benefit funds.
Points Providers: Points providers may include entities that offer incentive points that can be accumulated by members, for example, by purchasing goods/services, participating in promotional activities, etc. and that can be redeemed as spend to purchase certain goods/services. Example incentive point programs may include loyalty rewards, airline miles, and various other types of incentive programs. In some cases, merchants may implement their own points programs. In other cases, merchants may utilize third-party points providers. Members may have associated accounts or purses managed by one or more points providers that include accrued points that can be exchanged for cash or cash equivalents, for example, to purchase certain goods/services from merchants. As with benefits providers, some points providers may impose rules governing purse spending that restrict, for example, the redemption of points for to certain products/services.
Banks: Banks may include financial entities that facilitate program funding and disbursement of funds to merchants.
Payment Networks/Issuer Processors: Payment networks may comprise the infrastructure associated with traditional electronic payment rails that connect members (i.e., consumers) with merchants, banks for the purposes of transferring funds electronically. Issuer processors may handle processing of payment (authorization, approval, denial, etc.) via the traditional payment rails of payment networks. Many existing payments networks rely on the ISO 8583 standard which defines a message format and a communication flow so that different systems can exchange transaction requests and responses.
Affiliates: Affiliates may generally refer to entities that are in some way affiliated with any of the above entities such as merchants, goods/services providers, benefits providers, points providers, etc. For example, in some cases an entity such as a member association may act as an affiliate to other entities, for example, to offer discounts on goods and/or services offered by those other entities. In some cases, any of the aforementioned entities may simultaneously act as affiliates to other entities. For example, an entity such as the American Automobile Association (AAA) may be considered a service provider with respect to certain services offered direct to members (e.g., roadside assistance), but may simultaneously act as an affiliate to other entities, for example, by offering discounts to members on goods and/or services offered by those other entities (e.g., merchants).
Program Sponsors: Program sponsors may include entities that utilize the introduced processing platform to define and manage programs (e.g., by setting rules, etc.) that can be utilized by at least some members, for example, to redeem discounts on purchases from merchants, accumulate and redeem points (including loyalty rewards, miles, and other incentives), etc. In some embodiments, program sponsors may include merchants, goods/services providers, benefits providers, points providers, banks, and/or any affiliates thereof. For example, a benefits provider such as a healthcare provider may utilize the introduced processing platform to set up a program through which members can receive discounts (e.g., based on available benefits) on purchases of certain goods from merchants. Similarly, a points provider such as an airline that offers reward miles may utilize the introduced processing platform to set up a program through which members can receive discounts (e.g., based on accumulated miles) on purchases of certain goods from merchants.

### Operating Environment

FIG. [symbol] shows a diagram of an example networked computing environment 100 in which the introduced processing platform can be implemented, according to some embodiments. The example environment includes computing devices associated with the processing platform 120, members 104, merchants 106, POS systems 107, program sponsors 105, financial systems 112, and other external services 114. As previously discussed, program sponsors may interact with the processing platform 120 to define and manage programs utilized by member and may include, for example, merchants 106, goods/services providers 107, benefits providers 108, points providers 110, affiliates 111, etc. The computing devices associated with each of these entities/systems may communicate with each other over one or more computer networks 130 (e.g., LAN, WAN, Internet, Worldwide Web, cellular network, USB, Bluetooth, WI-FI, NFC, etc.).

The processing platform 120 may represent any combination of hardware and or/software for executing instructions to carry out the functionalities described herein. For example, the processing platform 120 may be implemented using one or more network connected server computer systems (physical or virtual) with associated non-transitory processor-readable storage media or other data storage facilities. For example, one or more databases for storing data (including metadata) may be accessible to the server computer systems. Instructions for carrying out certain processes described herein may be implemented as software instantiated in a computer-readable medium or computer-readable storage medium on a machine, in firmware, in hardware, in a combination thereof, or in any applicable known or convenient device or system. This and other modules, sub-modules, or engines described in this specification are intended to include any machine, manufacture, or composition of matter capable of carrying out at least some of the functionality described implicitly, explicitly, or inherently in this specification, and/or carrying out equivalent functionality

In some embodiments, the processing platform 120 comprises an internet-based web service and/or a cloud-computing service. For example, the processing platform 120 may be implemented (at least partially) in instructions executed by computing entities in a cloud-computing environment. Such a cloud-computing environment may be hosted by a third-party cloud-computing provider. For example, Amazon™ offers cloud computing services as part of the Amazon Web Services (AWS) platform. One or more of the functionalities of the processing platform 120 may be implemented using products and services associated with a cloud-computing platform such as Amazon™ AWS or Microsoft Azure™. In an illustrative embodiment, computing functionality is provided using virtual computing entities (e.g., Amazon™ EC2 virtual server instances and or Lambda event-based computing instances) executing across one or more physical computing devices and storage functionality is provided using scalable cloud-based storage (e.g., Amazon™ S3 storage) and/or managed databases, data warehouses, etc. (e.g., Amazon™ Aurora, Amazon™ DynamoDB, Amazon™ Redshift, Google™ Spanner, etc.).

Various users may use computing devices to interact with and access the services of the processing platform 120. Users, in this context, may include members 104 and administrators/managers associated with any of platform 120, merchants 106, POS systems 107, benefits providers 108, points providers 110, financial systems 112, and other external services 114. In some embodiments, computing devices may execute an application or “app” that communicates with the processing platform 120 via any suitable communications interface. In some embodiments, interaction between an application instantiated at a computing device and the processing platform 120 may be via an application programming interface (API). Computing devices may include any number of types of devices configured to process data and communicate with other devices via a communication network 130. Examples of such devices include desktop computers, laptop computers, smart phone devices, tablet devices, digital assistant devices (e.g., Amazon Echo™), wearable computing devices, smart televisions, video game consoles, etc.

The various systems, subsystems, and/or processor-based devices are capable of communications, for example, via the one or more networks 130 which may be, for instance, packet switched communication networks, such as the Internet, Worldwide Web portion of the Internet, extranets, intranets, and/or various other types of telecommunication networks such as cellular phone and data networks or channels, and plain old telephone system (POTS) networks. The type of communication infrastructure should not be considered limiting. The communication network 130 may take any of a large variety of forms, and may include modems (e.g., DSL modem, cable modem), routers, network switches, and/or bridges, etc.

The financial systems 112 may include, for example, computing systems of a merchant's acquiring bank, computing systems of an issuing bank, computing systems of a payment network, etc. An acquiring bank may be a bank or other financial institution that processes payments (e.g., credit or debit card payments) on behalf of a merchant. The acquirer acquires the payments from an issuer. The issuer (or issuing bank) is a bank or financial institution that offers a financial account (e.g., credit or debit card account) to the users such as members 104. The issuer may issue payments to the acquirer on behalf of such users.

In some embodiments, the environment 100 can accommodate traditional payment card transactions (i.e., those involving reading of a physical payment card at a merchant's location), card-not-present (CNP) transactions (i.e., those where a payment card is not physically presented or otherwise used), cash transactions, etc., as well as transactions that involve the processing platform 120.

In a traditional payment card transaction, for example, a payment card (e.g., a credit card) is read at the POS system 107 of a merchant 106. The term “read” refers to any manner of triggering a card reader to read data from a card, such as by passing a card into or through a magnetic stripe card reader, optical scanner, smartcard (card with an embedded IC chip) reader (e.g., an EMV-compliant card reader), radio frequency identification (RFID) reader, or the like. The POS system 107 may send data obtained, or read, from the card (e.g., the cardholder's name, credit card number, expiration date, card verification value (CVV), etc.) to a computing system of the merchant's acquiring bank. The acquiring bank may then send this data to the computing system of the card payment network (e.g., Visa™ or MasterCard™), which forwards the data to the computing system of the issuing bank. If the transaction is approved by the issuing bank, a payment authorization message is sent from the issuing bank to the merchant's POS system 107 via a path opposite of that described above.

In an example card-not-present transaction, a user may place an online order by transmitting the data of a credit card from a computing device (e.g., a smartphone) to the POS system 107 of the merchant 106. The POS system 107 in this context can include, for example, a web server for receiving the online order information. Then the POS system 107 sends the data of the card to the acquiring bank. The acquiring bank, the issuing bank, and payment network then complete the transaction in a way similar to the traditional credit card transaction described above.

In some embodiments, the POS system 107 may include an application associated with processing platform 120 installed on the POS system 107. In such embodiments, the processing platform 120 can communicate information through the application, such as information related to transactions conducted at the POS system 107. Information related to transactions may include, for example, basket contents, spend confirmation, member information, account links, transaction date/time, transaction ID, transaction item description, transaction location, payment card information (e.g., a cardholder's name, payment card number, expiration date, card verification value (CVV), etc.), among others.

In some embodiments, the POS system 107 may include a mobile application installed on a computing device (e.g., a smartphone) of a member 104. In such embodiments, the processing platform 120, through the mobile application, may communicate information related to the transaction, for example, a code (e.g., a QR code) to identify the member, redeem an offer such as a discount, etc.

The networked environment 100 may also include one or more external services 114 that may be accessed by or integrated with the processing platform 120, for example, via networks 130. The term “external” in this context may refer to services generated, operated, managed, owned or otherwise provided by an entity other than a provider of processing platform 120. In other words, external services 114 may include services offered by a third-party such as Facebook™ or Google™ (e.g., via an API) that expands and/or off-loads certain functionalities described herein with respect to the processing platform 120. As an illustrative example, certain computer processing and/or data storage functionalities may be offloaded to external cloud computing services such as Amazon™ AWS. As another illustrative example, communications to users (e.g., members 104 and/or administrators/managers) may be handled by one or more external social media services such as Facebook™ and/or one or more external messaging services such as a short messaging service (SMS) or email by another provider. External services 1114 may further include any other external services that may be utilized to implement the functionalities described herein such as search engine services, e-commerce services, data analytics services, data storage services, cloud-computing services, location services, etc.

### Processing Platform Architecture

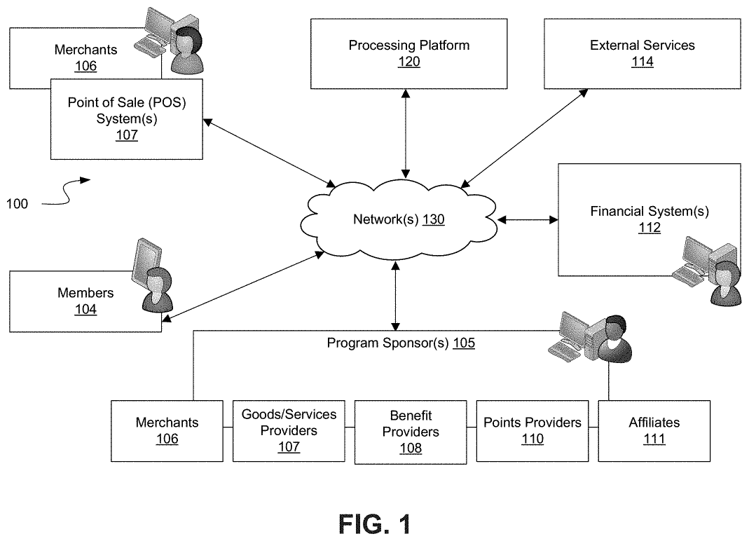

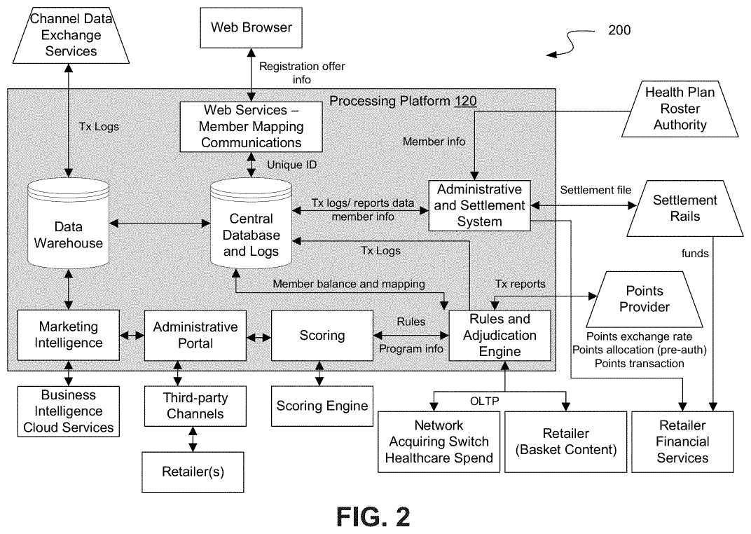

FIG. 2 shows an architecture and flow diagram of an example computing architecture 200 that includes the processing platform 120 shown in FIG. 1. The components of the processing platform 120 are depicted within the grey box with the diagram of FIG. 2 depicting interaction with various components external (i.e., outside the grey box) to the processing platform 120 such as payment settlement rails, for example, provided by the traditional payment network infrastructure includes as part of the financial systems 112 of FIG. 1.

In some embodiments, the platform 120 can be designed to operate as a cloud application, accessible to merchants directly or through pre-existing merchant payment and loyalty networks. The processing platform 120 may also be deployed in a local area network configuration should the situation apply.

As depicted in FIG. 2, the processing platform 120 includes a rules and adjudication engine as a primary processing system for transactions. The rules and adjudication engine may be configured to support various functionalities of the processing platform such as:
Real-time conversion and redemption of sponsor program points, miles, and other alternative currency as spendable currency (e.g., dollars);
Restricting redemption to specific, segmented members, merchants, and/or for specific products/services;
Redemption of sponsored discounts during payment transaction processing;
Redemption of sponsored discounts through merchant incentive systems;
Scoring or weighting of products to allow selective application of incentives;
Adjudication of market basket content to determine eligibility for filtered spending;
Data analytics on transaction logs;
Settlement reporting; and
Other functionalities.

In some embodiments, the rules and adjudication engine is configured to rely on existing data in the payment processing ecosystem to support transactions. The data may include:
Member information, including:
   Member identifier (ID) (e.g., name, username, account number, phone number, email address, etc.)
   Device ID (e.g., device UUID, device serial number, device type, mobile number, etc.)
   Geo-location information (e.g., based on device GPS)
   Member status
Network/Issuer Processor information, including:
   Access credentials
   Member mapping to Programs
   Settlement information
Merchant information, including:
   Merchant ID
   Physical store location
   Product mapping
   Settlement information
Program (e.g., benefits program, points program, etc.) information, including:
   Program ID
   Program content (discounts, spend filters, product catalogs)
   Sponsor funding source
   Sponsor financial reconciliation
Product information, including:
   Eligible product catalogs
   Nutritional information and scores

Spend transactions processed by the processing platform 120 may contain information about the “market basket” content of the purchase activity by a particular member. The market basket content in this context may represent a collection of line items, each of the line items representative of a particular product (or service) selected by the member to purchase from the merchant.

Notably, the spending process flow implemented by the processing platform 120 may involve the use of alternative processing rails such as points redemption rails, discount rails, loyalty rails, etc., in addition to traditional payment rails to process transactions. For example, in some embodiments, the processing platform 120 causes alternative fund sources such as benefit funds and/or exchangeable points to be automatically applied as discounts through in lane processing at a merchant POS system before settling any remaining balance through using traditional payment rails (e.g., credit card payment processing). The manner in which the processing platform 120 seamlessly integrates alternative funds (e.g., benefits, points, etc.) from various sources (e.g., benefits providers, points providers, etc.) with merchant POS systems and the existing payment processing ecosystem represents significant technological improvement over traditional payment processing systems that rely solely on traditional payment rails.

The spending process flow implemented by the processing platform 120 can be applied for all transactions, regardless of origination. Requisite information is staged within the platform 120 to support at least three primary spending types; 1) points and miles redemption, 2) rewards and incentives redemption, and 3) third-party funds such as benefits funds. Each function may rely on the platform 120 for its core processing, but may utilize separate interfaces (e.g., separate APIs) to support functionality.

Spending with Purse Management

Spending refers to the function of allowing funds from multiple accounts to be consumed for only specific products and/or services. The processing platform 120 operates in conjunction with the merchant POS systems and/or merchant loyalty infrastructure to implement this spending function. In some embodiments, the platform 120 applies the spending rules and restrictions to line items in a market basket and payment is restricted to authorized items.

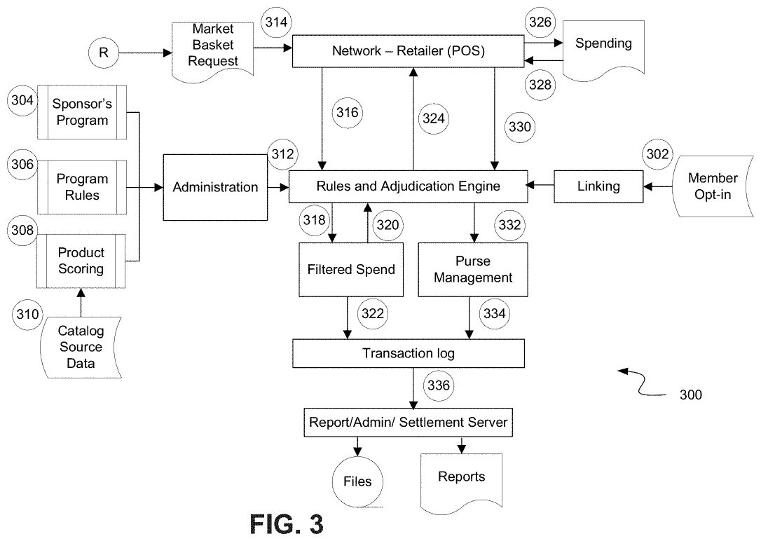

FIG. 3 shows a flow diagram illustrating an example process 300 for spending with purse management using the introduced processing platform 120.

At step 302, a member registers with the processing platform 120 by linking various accounts. For example, using a computing device, a member may elect to link one or more of their accounts to the processing platform 120. These linked accounts may include, for example, incentive/loyalty rewards accounts (e.g., points, miles, etc.), benefits accounts, bank accounts, etc. In some embodiments, step 302 may include transmitting, by a computing device of the member, information regarding the accounts (e.g., a loyalty ID, Affiliate ID, etc.) to the platform 120. This information may be stored in one or more databases at the platform 120.

At step 304, 306, and 308 program sponsors define certain parameters for one or more programs to be offered through the processing platform 120, rules for such programs, and a scored product eligibility catalog for applying such rules (respectively). As previously mentioned, in some situations, program sponsors may include merchants, goods/services providers, benefits providers, points providers, or any affiliates thereof. For example, a nutritional benefits sponsor (e.g., the U.S. Department of Agriculture through the Supplemental Nutrition Assistance Program (SNAP)) may define a program for using SNAP benefits through the platform 120, nutrition-based rules restricting which types of foods can be purchased with SNAP funds, and a catalog of eligible products that satisfy such rules. Step 308 of defining the scored product eligibility catalog may include accessing product catalogs built, for example by other entities, at step 310. In some embodiments, steps 304, 306, and 308, may include transmitting, by a computing device of a program sponsor, one or more program parameters, rule constructs, and/or product lists to the platform 120. This information may be stored in one or more databases at the platform 120.

At step 312, rules engine tables for the various programs are maintained at platform 120 based on data received from program sponsors and stored in one or more databases at platform 120. In some embodiments, program administrators may utilize an administration portal to manage the rules engine tables for their respective programs.

At step 314, a market basket request is submitted for adjudication via the platform 120. For example, after collecting items at a physical store, a member may submit product items for scanning at a merchant POS system. The scanned items to be purchased by the member comprise the market basket request. The market basket request may include, for example, an itemized listing of product identifiers such as a product SKU. This product identifiers may be associated with costs/discounts, or other attributes via the merchants POS system.

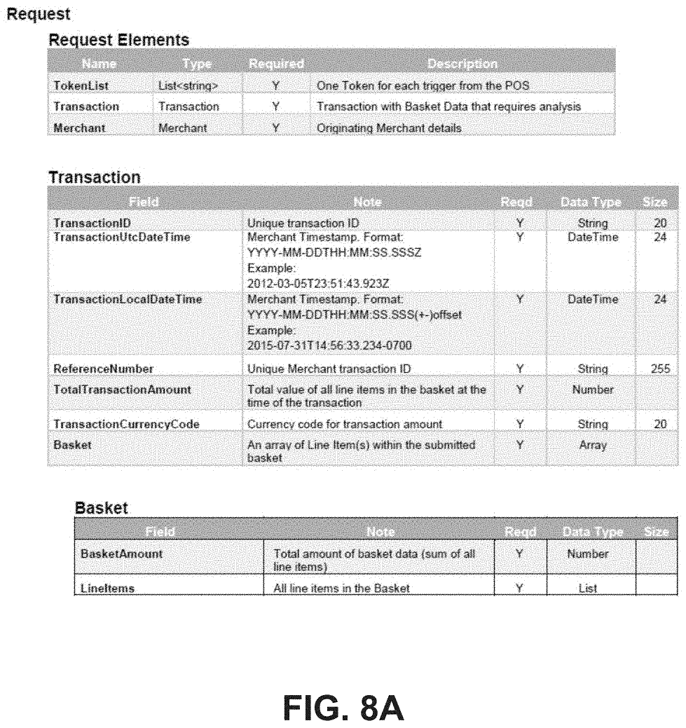

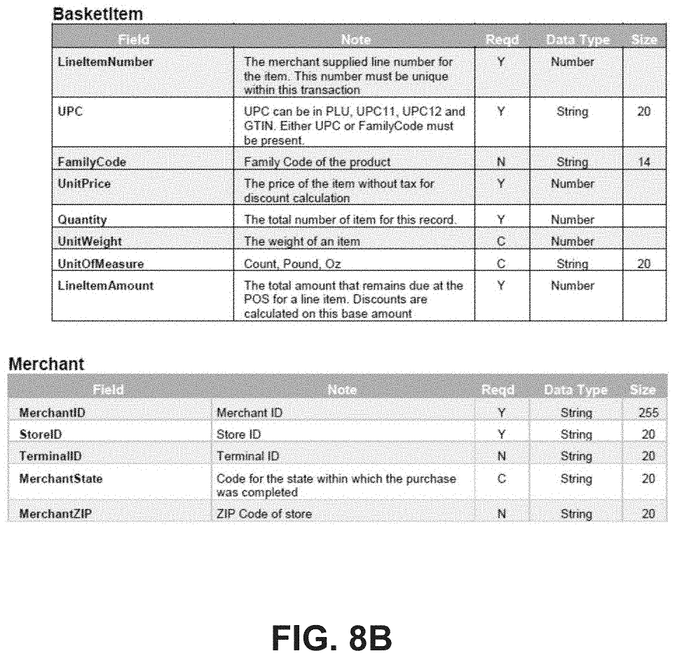

FIGS. 8A-8B show example data elements that may be included in a market basket request. The market basket request may comprise, for example, a nested JSON message. For example, FIGS. 8A-8B show the upper level elements off the request including details of the transaction and the originating merchant. The nested elements of the transaction element may include, for example, a basket detail, which itself includes a basket amount and listing of basket items. As shown, each of the basket items may include data such as a UPC, unit price, a quantity, a line item amount, etc. As shown, the merchant detail may include, for example, a Merchant ID, a Store ID, a merchant location, etc. A person having ordinary skill in the art will recognize that the data elements depicted in FIGS. 8A-8B are just examples and are not to be construed as limiting. A market basket request can similarly be implemented using other types of data or data structures.

Returning to FIG. 3, at step 316, the market basket is transmitted from the merchant POS system and/or a related merchant network to the rules and adjudication engine at the processing platform 120. The market basket transmission may include line item and basket detail data included, for example, in a JavaScript Object Notation (JSON) file. In some embodiments the market basket is transmitted via a message based on ISO 8583.

At step 318, the rules and adjudication engine performs adjudication of the transaction by analyzing each line item, for example, against certain program rules relevant to the member to apply filtered spend. For example, the rules and adjudication engine may identify product items in the market basket to which benefit funds and/or points may be applied.

In some embodiments, the rules and adjudication engine analyzes the entire content of a market basket, sorts line items into logical groups in order to apply discounts, and returns detailed discount information for application by the merchant POS system.

In this context, a “group” is a set of line items that have the same processing requirements. For example, a group may be all line items that are not eligible for discounts and not eligible for filtered spend. A group may also be a set of line items that are eligible for filtered spend discounts. As one final example, a group may be a set of items that satisfy a complex discount rule, such as ‘Buy any three of Libby Brand vegetables and get the less expensive fourth can free.’ Hence, a response to an analyze basket request may contain a large number of groups within the single transaction.

At step 320, the transaction is returned with a response including a processed line item and basket detail. As mentioned above, in some embodiments, the response to the market basket request may include all the line items organized into one or more groups. Each line item in the processed market basket may be annotated with each discount available, across sponsors and programs. As such, a given line item in the market basket response may be represented in one or more groups and may include multiple discounts, for example, from different sponsors.

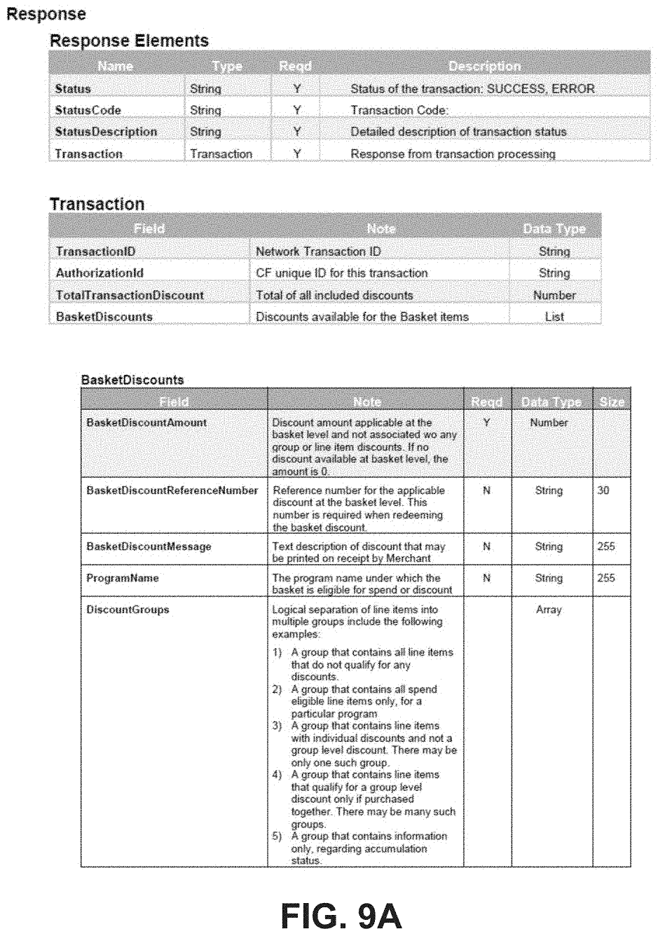

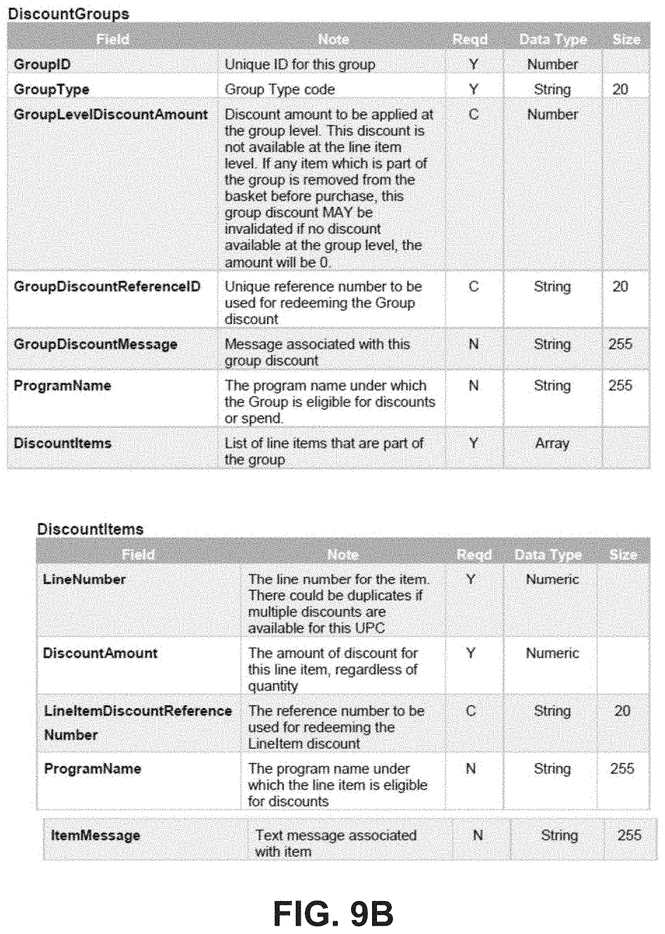

FIGS. 9A-9B show example data elements that may be included in a market basket response. As with the market basket request, the market basket response may comprise, for example, a nested JSON message. For example, FIGS. 9A-9B shows the upper level elements of the response including details of the transaction. The nested elements of the transaction element may include, for example, a total transaction discount and a listing of the discounts for basket items. As shown, the basket discounts may include data such as a discount amount at the basket level, data regarding the program(s) providing the discount, as well as a logical separation of line items into groups, as discussed above. Each discount group may include information such as a discount amount at the group level, data regarding the program(s) providing the discount, and a listing of line items included in the group to which the discount will be applied. Each discount item may include, for example, a discount amount, and data regarding the program(s) providing the discount. A person having ordinary skill in the art will recognize that the data elements depicted in FIGS. 9A-9B are just examples and are not to be construed as limiting. A market basket response can similarly be implemented using other types of data or data structures.

Returning to FIG. 3, at step 322, the transaction is logged, for example, in one or more databases at the processing platform 120.

At step 324, the processed market basket is returned to the merchant POS system and/or associated merchant network after processing. The processed market basket may include the processed line item and basket detail. In some embodiments the processed market basket is transmitted via a message based on ISO 8583.

At step 326, the basket response from platform 120 is applied, by the merchant POS system, as spend for authorization approval through payment rails such as traditional payment network.

At step 328, an acknowledgement is received by the merchant POS system from the payment network for spend completion. This acknowledgment may include an authorization approval.

At step 330, the merchant POS system transmits a confirmation of spend to the platform 102. In some embodiments, the confirmation is transmitted via a message based on ISO 8583.

At step 332, the rules and adjudication engine adjusts (i.e., increments or decrements) the one or more linked accounts of the user based on a transaction value and in response to the spend confirmation received from the merchant POS system.

At step 334, the spend transaction is logged, for example, in one or more databases at the platform 120.

At step 336, the transaction logs may be synched with a data warehouse and/or reports may be generated for analytics.

### Catalog Management

Each program may be limited in scope as to what products and/or services are available. In some embodiments, the processing platform 120 uses eligibility catalogs to bound the limits of the program and its related products. Each program sponsor defines a set of catalogs, for example, through a web interface or other electronic data interchange processes.

The program catalog usually contains a list of product identifiers such as UPCs and/or PLUs that describe the way products are identified within specific merchants. Accordingly, a unique catalog may be defined for a first merchant that is different than anther catalog defined for a second merchant. In some embodiments, the processing platform 120 may handle the assimilation of merchant-specific content into the various program catalogs.

In some embodiments, the processing platform 120 may facilitate scoring of product catalogs and/or lists of product codes. For example, using this feature, a health plan program may allow only products that score 90 or above on a nutritional scale to be eligible for a benefit or for the purchaser to receive the maximum benefit allowed by the sponsor. If a particular product scores below a given threshold (e.g., 90) a member may not be able to apply their health plan benefits to purchase the product or may only be allowed to apply benefits for a portion of the cost (e.g., 50%). Multiple scores and filters can be applied to an item in order to calculate eligibility and level of benefit. Using the health plan example, nutritional scoring may enhance or further be filtered by a separate weighting, such as an enhanced score for products low on the glycemic index.

Catalogs represent a collaboration between a merchant (e.g., a grocery store) and a program sponsor (e.g., a health plan or affiliate). The merchant may establish which products and services are available in their ecosystem and the program sponsor may select eligible products from what is available and define benefit allocations for eligible products. Both the merchant and the sponsor may choose to evaluate and display extended information about products, such as nutritional score and other attributes.

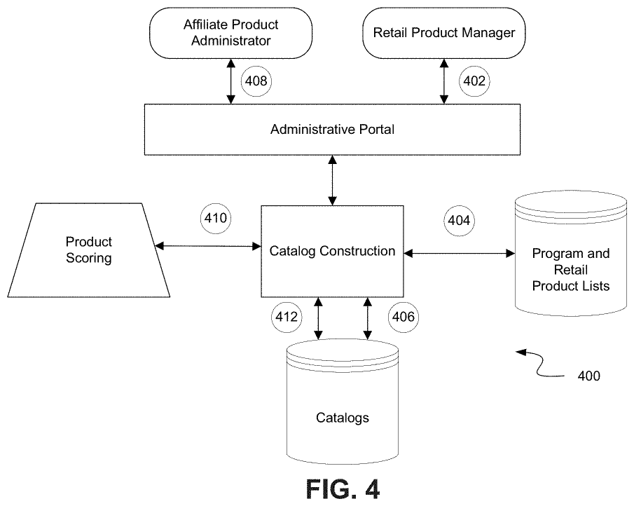

FIG. 4 shows a flow diagram illustrating an example process 400 for catalog management using the introduced processing platform 120.

At step 402, a merchant establishes product availability, for example, by entering product information (e.g., product codes, family codes, descriptions, etc.) via an administrative portal for transmission to the processing platform 120.

At step 404, the product information entered by the merchant is stored in product catalog at the processing platform 120.

At step 406, product catalogs are stored by merchant and by program. In other words, the product information is stored among multiple segmented product catalogs specific to certain merchants and/or programs.

At step 408, a program sponsor or affiliate enters program parameters that define the scoring/filtering requirements for a given program. For example, a health plan affiliate may select eligible food products and/or exclude certain products from a grocery store product catalog and/or may define nutritional scoring requirements. Program parameters may similarly be entered via an administrative portal for transmission to the processing platform 120.

At step 410, products included in one or more product catalogs are scored based on one or more applicable criteria. For example, food products may be scored based on nutrition. In some embodiments, a provider of platform 120 may perform product scoring. In other embodiments, product scoring may be performed by a third-party.

At step 412, scored segmented product catalogs are stored for later use by the rules and adjudication when processing transactions.

### Earning Event Notification

As previously discussed, sponsors can establish programs that enable members to earn rewards, for example, by purchasing certain items at certain merchants. For example, a business rule supporting SNAP members is articulated as: “If a SNAP member spends a total of $10 at a given merchant during a given month, that SNAP member will receive a $10 discount toward specific UPCs or PLUs during the next month.” Another example rule may include: “If a member performs a blood pressure test at a specific kiosk with a specific merchant, then the member receives a $20.00 general spend reward.” Such rules may require that an earning event be reported to the platform 120 when an eligible member performs according to the rule. For example, an event may be reported to the platform 120, when an eligible SNAP member spends money at a specific merchant, as well as the amount that was spent. The reported spending is accumulated at platform 120 for the SNAP member during the reward accumulation period and when the threshold is met, a reward is issued to the member for later redemption.

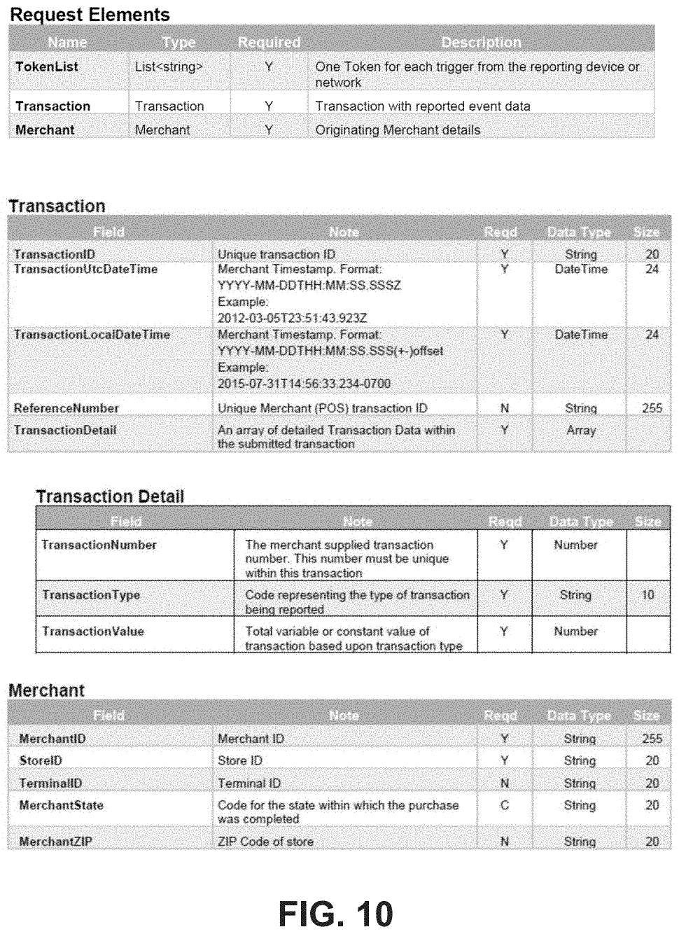

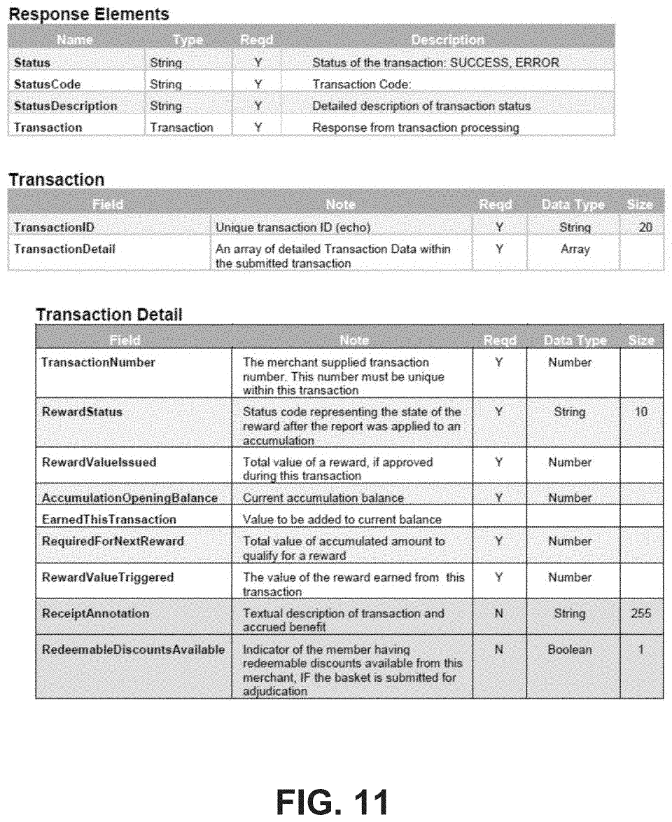

FIG. 10 shows example data elements that may be included in an earning event request, for example, sent by a merchant POS system to platform 120, to report an earning event. FIG. 11 shows example data elements that may be included in an earning event response, for example, sent by platform 102 to a merchant POS system in response to the request. Both the earning event request and response may comprise, for example, nested JSON messages. As shown in FIG. 11, the earning event response may include information regarding a rewards status representing a state of the reward after the report was applied to accumulation as well as a value of a reward based on the status, if applicable. A person having ordinary skill in the art will recognize that the data elements depicted in FIG. 10 and FIG. 11 are just examples and are not to be construed as limiting. The earning event requests and responses can similarly be implemented using other types of data or data structures.

### Purse Staging—Points Redemption

The processing platform 120 allows inceptive points and/or reward miles accrued by members to be redeemed and used as cash, for example, to be applied as a discount when purchasing products and services. Participation and redemption options can be made available to members to, for example:
Associate subscribed loyalty points to a member account;
Stay informed about sponsor offers to redeem points;
Establish rules for each points/miles category; and
Redeem points/miles as spend.

Points sponsors can make accumulated inceptive points available to members to optionally use as cash when purchasing products and services. Using the processing platform 120, a points sponsor can, for example:
Announce association with merchants and indicate points exchange rates and rules for transactions processed via the platform 120;
Allow members to associate points sponsor and merchant programs via a website or mobile application;
Establish exchange accounts and rules of currency conversion;
Maintain and approve points consumption (e.g., in real-time and/or off-line);
Settles with a single entity (i.e., a provider of platform 120); and
Monitor incentive campaigns and review acceptance/usage information.

Member organizations have opportunities to brand points to offered programs, providing a context for consuming points for a particular benefit. Using platform 120, member organizations can, for example:
Operate branded websites and mobile applications used by members to associate and report points and membership association; and
Monitor campaigns and review acceptance/usage information and manage a membership base.

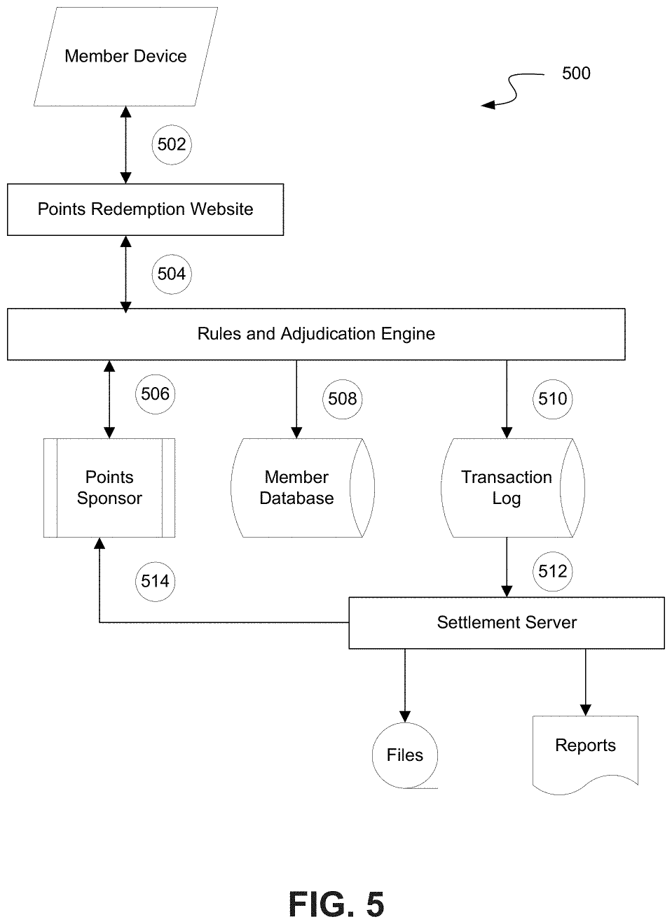

The central processes of points utilization and redemption may be consistent across various use cases through the use of the integrating processing platform 120. FIG. 5 shows a flow diagram illustrating an example process 500 for points/miles acquisition using the introduced processing platform 120. A general sequence of events, as reflected in FIG. 5, enables 1) a member to acquire points and miles at a specified exchange rate and redeem the points as cash, and 2) a points sponsor to establish rules of exchange, acceptance, and/or redemption for various programs that are then enforced by the processing platform 120.

At step 502, a member may select from various points/miles opportunities offered by points/miles sponsors via platform 120. For example, a member may access a website or application via a computing device such as a mobile device and select one or more points/mile programs offered by various points/miles sponsors via the platform 120.

At step 504, the rules and adjudication engine retrieves the points and mile options selected by the member and report those selections to the applicable sponsors of the selected programs.

At step 506, the rules and adjudication engine authorizes the points/miles with the applicable sponsors (e.g., a points provider or affiliate). The authorization request may include, for example, a Member ID.

At step 508, the rules and adjudication engine records points/miles authorized by the sponsors into a member account for the member.

At step 510, the rules and adjudication engine logs points/miles exchanged during transactions via the platform 120.

At step 512, the logged points/miles transactions are communicated to a settlement server.

At step 514, the settlement server confirms the exchange of points/miles with the applicable sponsors.

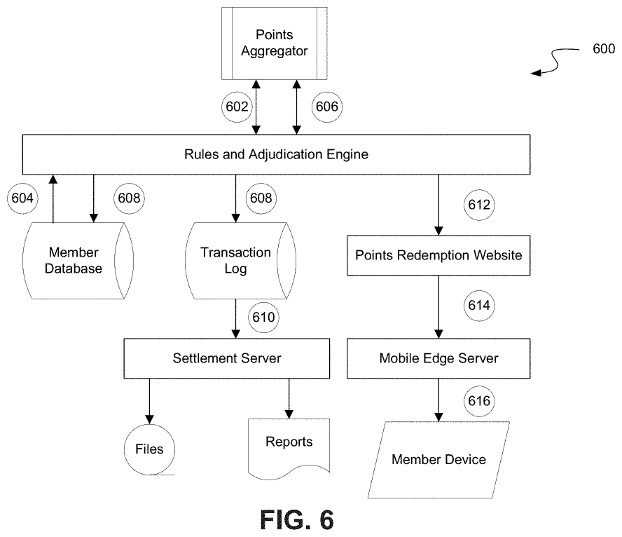

Using platform 120, points and/or miles can be redeemed for cash at some point after the points and/or miles have been acquired by members. The redemption process is a stand-alone process, consuming points and miles that have been pre-authorized by the points/or mile providers. FIG. 6 shows a flow diagram illustrating an example process 600 for points/miles redemption using the introduced processing platform 120.

At step 602 the rules and adjudication engine requests the value of points from a points aggregator. The request may include, for example, a Member ID and an authorization request.

At step 604, the rules and adjudication engine retrieves a member balance from a member database, for example, using the Member ID.

At step 606, the rules and adjudication engine authorizes currency (e.g., dollars) exchange.

At step 608, the rules and adjudication engine updates the member balance and/or logs the transaction.

At step 610, the rules and adjudication engine updates the points redemption website to reflect the authorized consumption of points.

At step 612, information regarding the points consumption transaction is forwarded, for example, to a mobile edge server, which then, at step 614, communicates the points consumption transaction to the member, for example, by transmitting a notification to a member computing device.

### Purse Staging—Rewards and Incentives Redemption

Rewards and incentives in the form of spendable currency (collectively called “discounts”) may be made available, via processing platform 120, to registered members. In some embodiments, these rewards and incentives may be made available to registered members based on segmented member demographics. Discounts may be associated with any Member ID that the merchant will honor. Examples may include a QR code on a mobile display device, member loyalty card number or phone number entered into the POS system, payment card, or a designated PayPal account, etc.

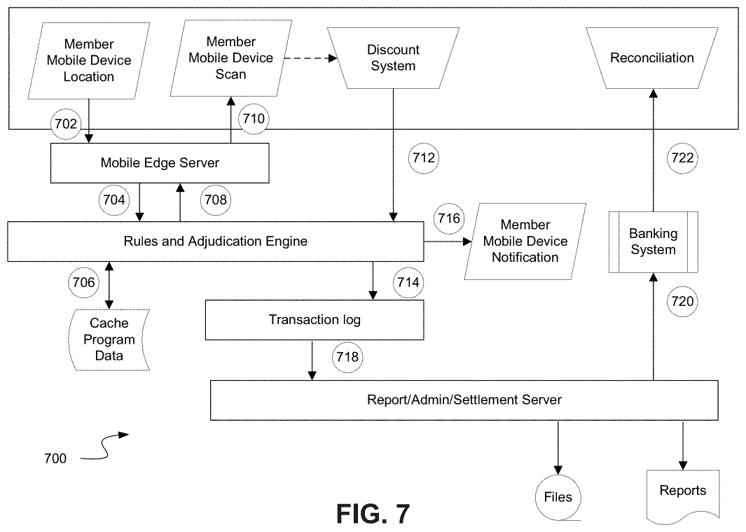

FIG. 7 shows a flow diagram illustrating an example process 700 for rewards and incentives redemption using the introduced processing platform 120. The example process 700 specifically reflects the use of a QR code displayed on a member's mobile device, where the QR code is issued in real-time based upon the member's geo-location. In such a case, the merchant's POS network must be capable of reading and redeeming a QR code. Note, however, that use of a QR code for member identification is not necessary in all embodiments. Process flows in other embodiments may differ from the process flow depicted in FIG. 7, for example, where distribution and redemption of discounts is through media other than a mobile device. Where notification is provided to the merchant in a non-real-time mode, the management and distribution of discounts may be performed directly between the merchant POS system and the rules and adjudication engine.

At step 702 a geolocation data gathered at a member computing device (e.g., a smartphone) is transmitted, via a computer network, to a mobile edge server and then at step 704 forwarded to the rules and adjudication engine of platform 120. The transmitted geolocation data may further include a Member ID specific to the member associated with the member computing device. Based on the received geolocation data, the rules and adjudication engine may determine that the member is currently located at, in proximity to, and/or moving towards a physical location of a particular merchant.

At step 706, the rules and adjudication engine may retrieve discount information applicable, for example, based on the received geolocation data for the member. As an illustrative example, the merchant which the member is located at may offer a discount for certain items. As another example, a third-party such as a products/services provider, points provider, benefits provider, affiliate etc. may offer discounts that can be applied at the particular merchant's physical location.

In any case, at step 708, the rules and adjudication engine may transmit details regarding an offer based on the retrieved discount information to the mobile edge server. These details may include, for example, a code such as a QR code based on the retrieved discount information that is configured to be readable by a POS system of the particular merchant.

At step 710, a message including the details regarding the retrieved offer is forwarded by the mobile edge server to the member computing device. For example, step 708 and 710 may comprise transmission of a message (e.g., via SMS) that includes a QR code or a link to a QR code.

At step 712, a redemption advisory message is transmitted to the rules and adjudication engine in response, for example, in response to a redemption event at the merchant POS system. The redemption event may include, for example, scanning of a QR code, entry of a numerical code, entry of a Member ID, etc. The redemption advisory message may include details of the transaction at the merchant POS to which the redeemed discount is applied.

At step 714, the rules and adjudication engine logs the redemption advisory message in a transaction log.

At step 716, the rules and adjudication engine may transmit a message to the member device regarding redemption of the discount. For example, the message may be a notification (e.g., sent via SMS), thanking the member for redemption of the discount and providing information regarding the applied discount and the transaction.

At step 718, the logged transaction may be made available for analysis, for example, via a reporting, administration, or settlement server.

At step 720, settlement is initiated, for example, by transmitting a settlement report to a banking system associated with the transaction.

At step 722, settlement is completed, for example, by transferring funds between the merchant POS system and the relevant banking system.

### Example Computing System

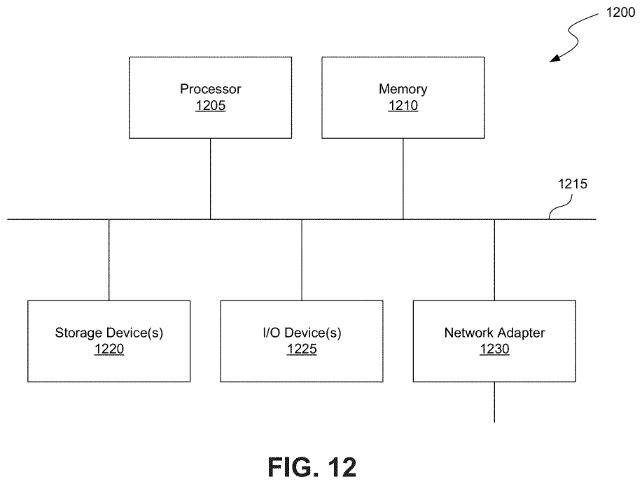

FIG. 12 is a block diagram of an example computing system 1200 as may be used to implement certain features of some of the embodiments. The computing system 1200 may be a server computer, a client computer, a personal computer (PC), a user device, a tablet PC, a laptop computer, a personal digital assistant (PDA), a cellular telephone, a telephone, a web appliance, a network router, switch or bridge, a console, a hand-held console, a (hand-held) gaming device, a music player, any portable, mobile, hand-held device, wearable device, or any other machine capable of executing a set of instructions (sequential or otherwise) that specify actions to be taken by that machine.

The computing system 1200 may include one or more processing units (e.g., central processing units (CPU) and/or graphical processing units (GPU) (collectively the “processor”) 1205, one or more memory units (collectively “memory”) 1210, one or more input/output devices 1225 (e.g., keyboard and pointing devices, touch devices, display devices, audio input/output devices, etc.) one or more storage devices 1220 (e.g., disk drives, solid state drives, etc.), and one or more network adapters 1230 (e.g., network interfaces) that can communicatively couple via an interconnect 1215. The interconnect 1215 is illustrated as an abstraction that represents any one or more separate physical buses, point to point connections, or both connected by appropriate bridges, adapters, or controllers. The interconnect 1215, therefore, may include, for example, a system bus, a Peripheral Component Interconnect (PCI) bus or a PCI-Express bus, a HyperTransport or industry standard architecture (ISA) bus, a small computer system interface (SCSI) bus, a universal serial bus (USB), IIC (12C) bus, an Institute of Electrical and Electronics Engineers (IEEE) standard 1394 bus (also called Firewire), or any other suitable system for facilitating communication between the various components of the example computing system 1200.

The memory 1210 and storage device 1220 are computer-readable storage media that may store instructions that implement at least portions of the various embodiments. In addition, the data structures and message structures may be stored or transmitted via a data transmission medium (e.g., a signal on a communications link). Various communications links may be used such as the Internet, a local area network, a wide area network, or a point-to-point dial-up connection, etc. Thus, computer readable media can include computer-readable storage media, e.g., non-transitory media, and computer-readable transmission media.

The instructions stored in memory 1210 can be implemented as software and/or firmware to program the processor 1205 to carry out actions described above. In some embodiments, such software or firmware may be initially provided to the processor 1205 by downloading the software or firmware from a remote system through the computing system 1200, e.g. via network adapter 1230.

The various embodiments introduced herein can be implemented by, for example, programmable circuitry, e.g., one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

What is claimed is:

1. A method comprising
receiving, by a computer system, from a benefits program sponsor, a set of rules and a product catalog for applying the set of rules;
generating, by the computer system, a rules engine table based on the set of rules and the product catalog received from the program sponsor;
storing, by the computer system, the rules engine table in a database;
receiving, by the computer system, via a computer network, a market basket request from a point of sale (POS) system associated with a merchant, the market basket request including a plurality of product identifiers, the plurality of product identifiers referencing a plurality of products submitted by a user to be scanned by a terminal associated with the POS system, the terminal located at a physical location associated with the merchant, the user having a linked benefits account managed by the benefits program sponsor;
processing, by the computer system, the market basket request using the rules engine table to apply a discount based on the set of rules associated with the rules engine table;
generating, by the computer system, and updated market basket request based on the applied discount;
transmitting, by the computer system, via the computer network, the updated market basket request to the POS system associated with the merchant;
receiving, by the computer system, via the computer network, from the POS system, an acknowledgement that the POS system has completed a transaction based on the updated market basket request; and
adjusting, by the computer system, the linked benefits account of the user by an amount corresponding to the applied discount in response to receiving the acknowledgement from the POS system.
